(19) United States
(12) Patent Application Publication
(10) Pub. No.: US 2024/0347943 A1
(43) Pub. Date: Oct. 17, 2024

(54) ELECTRICAL CONNECTOR, CONNECTION STRUCTURE, AND METHOD FOR MANUFACTURING ELECTRICAL CONNECTOR

(71) Applicant: SUMITOMO ELECTRIC INDUSTRIES, LTD., Osaka (JP)

(72) Inventors: Taisuke NAGASAKI, Osaka (JP); Takeshi INOUE, Osaka (JP); Mitsuaki TAMURA, Osaka (JP); Tatsuo MATSUDA, Kanuma-shi (JP)

(73) Assignee: SUMITOMO ELECTRIC INDUSTRIES, LTD., Osaka (JP)

(21) Appl. No.: 18/626,974

(22) Filed: Apr. 4, 2024

(30) Foreign Application Priority Data
Apr. 11, 2023 (JP) 2023-064271
Dec. 11, 2023 (JP) 2023-208851

(51) Int. Cl. H01R 12/71; H01R 43/28

(52) U.S. Cl. CPC H01R 12/716; H01R 43/28

(57) ABSTRACT

An electrical connector includes a ferrule and a plurality of electric wires. The ferrule includes a ferrule main body including a front end and a rear end located opposite to the front end in a first direction, and a plurality of insertion holes that extend in the first direction within the ferrule main body and that respectively open at the front end. The plurality of electric wires are held in the plurality of insertion holes, respectively. Each of tip ends of the plurality of electric wires is exposed from each of the plurality of insertion holes at the front end.

### CROSS-REFERENCE TO RELATED APPLICATIONS

This application claims the benefits of priority from Japanese Patent Application No. 2023-064271 filed on Apr. 11, 2023, and Japanese Patent Application No. 2023-208851 filed on Dec. 11, 2023, the entire contents of which are incorporated herein by reference.

### TECHNICAL FIELD

The present disclosure relates to an electrical connector, a connection structure, and a method for manufacturing the electrical connector.

### BACKGROUND

JP2017-069166A discloses a card edge type electrical connector. This electrical connector includes a first housing and a second housing. In this electrical connector, a plurality of electric wires held in the second housing are electrically connected to a plurality of electrode pads of a counterpart unit through a plurality of first terminals and a plurality of second terminals loaded in each of the housings. JP2011-023329A discloses another type of this electrical connector.

### SUMMARY

An electrical connector according to an embodiment of the present disclosure includes a ferrule and a plurality of electric wires. The ferrule includes a ferrule main body and a plurality of insertion holes. The ferrule main body include a front end and a rear end located opposite to the front end in a first direction. The plurality of insertion holes extend in the first direction within the ferrule main body. Each of the plurality of insertion holes open at the front end. Each of the plurality of electric wires is held in each of the plurality of insertion holes. In this electrical connector, each of the tip ends of the plurality of electric wires is exposed from each of the plurality of insertion holes at the front end.

### BRIEF DESCRIPTION OF THE DRAWINGS

FIG. 1 is a schematic cross-sectional view showing a connection structure according to one embodiment.

FIG. 2 is a perspective view of an electrical connector according to one embodiment.

FIG. 3 is a perspective view showing a state before one cable is inserted in the electrical connector shown in FIG. 2.

FIG. 4 is a cross-sectional view showing an example of the electric wire used in the electrical connector shown in FIG. 2.

FIG. 5 is a flowchart showing a method for manufacturing an electrical connector according to one embodiment.

FIG. 6 is a schematic perspective view showing an example of a connection structure in a conventional electrical connector.

FIG. 7 is a schematic perspective view showing another example of the connection structure in a conventional electrical connector.

FIG. 8 is a graph for describing effects of the electrical connector shown in FIG. 2.

FIG. 9 is a graph for describing effects of the electrical connector shown in FIG. 2.

FIG. 10 is a schematic cross-sectional view showing a connection structure according to a modified example.

FIG. 11A is an enlarged view of a region A in the connection structure shown in FIG. 10, and FIG. 11B is an enlarged view of a region A in the connection structure shown in FIG. 10.

### DETAILED DESCRIPTION

### Problems that this Disclosure Seeks to Solve

In the electrical connector described in JP2017-069166A, each of the electric wires is electrically connected to each of a plurality of electrode pads of the other unit through a first terminal and a second terminal having different shapes (for example, an outer diameter, a cross-sectional shape, or the like) of the electric wire. When there is a portion in a conduction path that differs from the shape of the electric wire in this way, mismatching in high frequency characteristic impedance may occur at the portion at which each of the electric wires is connected to each of the connection terminals or at a change point in a structure.

### Effects of the Present Disclosure

According to the present disclosure, it is possible to provide an electrical connector capable of curbing mismatching in high frequency characteristic impedance.

### Description of Embodiments of the Present Disclosure

First, contents of the embodiments of the present disclosure will be listed and described.

[1] An electrical connector according to one embodiment includes a ferrule and a plurality of electric wires. The ferrule includes a ferrule main body and a plurality of insertion holes. The ferrule main body includes a front end and a rear end located opposite to the front end in a first direction. The plurality of insertion holes extend in the first direction within the ferrule main body. Each of the plurality of insertion holes open at the front end. Each of the plurality of electric wires is held in each of the plurality of insertion holes. In this electrical connector, each of tip ends of the plurality of electric wires is exposed from each of the plurality of insertion holes at the front end.

In the above electrical connector, each of the tip ends of the plurality of electric wires is exposed as it is from each of the plurality of insertion holes at the front end of the ferrule main body. According to such a configuration, a function of contacts of the electrical connector can be substituted by the tip ends of the respective electric wires. Thus, conduction can be achieved without interposing any other conductive member between each of the tip ends of the electric wires and a target conductor. As a result, according to the electrical connector, it is possible to curb occurrence of mismatching in high frequency characteristic impedance.

[2] As one embodiment, in the electrical connector of [1] above, the ferrule main body may be made of an insulating material. In this case, it is possible to prevent the plurality of electric wires from being electrically connected to a conductor other than the conductor provided in the member to which the electrical connector is connected.

[3] As one embodiment, in the electrical connector of [1] or [2] above, the plurality of insertion holes may be formed in the ferrule main body to be arranged side-by-side in a second direction intersecting the first direction. In this case, the plurality of electric wires can be disposed with a higher density at the front end.

[4] As one embodiment, in the electrical connector of [1] or [2] above, the plurality of insertion holes may include a first plurality of insertion holes and a second plurality of insertion holes. The first plurality of insertion holes may be formed side-by-side in the second direction intersecting the first direction. The second plurality of insertion holes may be formed side-by-side in the second direction and at different positions from those of the first plurality of insertion holes in a third direction intersecting the first direction and the second direction. In this case, the plurality of electric wires can be disposed with a higher density at the front end.

[5] As one embodiment, the electrical connector of [4] above may further include a plurality of optical fibers. The plurality of electric wires may be held in the first plurality of insertion holes, respectively. The plurality of optical fibers may be held in the second plurality of insertion holes, respectively. In this case, both the plurality of electric wires and the plurality of optical fibers can be disposed with high density.

[6] As one embodiment, in the electrical connector according to any one of [1] to [5] above, each of the tip ends of the plurality of electric wires may be flush with a front end surface in which the plurality of insertion holes are open at the front end, or may protrude outside from the front end surface. In this case, the function of the contacts of the electrical connector can be more reliably realized by the tip ends of the electric wires. Thus, the mismatching in high frequency characteristic impedance can be curbed more reliably.

[7] As one embodiment, in the electrical connector according to any one of [1] to [5] above, each of the tip ends of the plurality of electric wires may be located inside each of the plurality of insertion holes at the front end. In this case, when the electrical connector is coupled to a mating member in the first direction, each of a plurality of conductors of the mating member can enter inside the insertion hole that holds the corresponding electric wire among the plurality of electric wires. Thus, a thickness of a connection structure including the electrical connector in the first direction can be reduced.

[8] As one embodiment, in the electrical connector of [7] above, a distance between each of the tip ends of the plurality of electric wires and a front end surface in which the plurality of insertion holes are open at the front end may be 30 μm or more and 600 μm or less. In this case, since the distance between each of the tip ends and the front end surface is 30 μm or more, the thickness of the connection structure including the electrical connector in the first direction can be made thinner. Furthermore, since the distance between each of the tip ends and the front end surface is 600 μm or less, each of the tip ends of the plurality of electric wires can be more reliably connected to a target conductor that has entered each of the insertion holes.

[9] As one embodiment, in the electrical connector of [7] or [8] above, each of the plurality of insertion holes may include a flared portion at the front end. The flared portion may widen from inside each of the plurality of insertion holes toward a front end surface in which the plurality of insertion holes are open. In this case, when the electrical connector is coupled to the mating member in the first direction, the flared portion of the insertion hole can guide a corresponding terminal among the plurality of terminals of the mating member into the insertion hole. Thus, in the direction intersecting the first direction, a position of each of the tip ends of the plurality of electric wires can be positioned with higher precision with respect to the corresponding terminal among the plurality of terminals.

As one embodiment, in the electrical connector according to any one of [1] to [9] above, each of the plurality of electric wires may include a tip end portion held in at least the plurality of insertion holes. The tip end portion may have a uniform outer diameter in the first direction. In this case, it is possible to more reliably curb the mismatching in high frequency characteristic impedance at the tip end portion at which the electrical connector is connected to another conductor.

As one embodiment, in the electrical connector according to any one of [1] to above, the plurality of insertion holes may have a circular or elliptical shape in a cross section intersecting the first direction.

As one embodiment, in the electrical connector according to any one of [1] to above, the plurality of electric wires may be integrated at least in a region that extends outward from the rear end. In this case, it becomes easier to handle the plurality of electric wires that extends outward from the rear end of the ferrule. Further, when the electrical connector is manufactured, work of inserting the plurality of electric wires into the ferrule becomes easy, and a configuration in which the plurality of electric wires are disposed with a high density at the front end can be easily realized.

A connection structure according to an embodiment includes a board and any one of the electrical connectors described in [1] to above. In this connection structure, the electrical connector may be mountable on the board so that the first direction intersects a surface direction of the board. In this case, when the plurality of electric wires are electrically connected to a conductor provided on the board, it is possible to substitute a function of contacts of the electric connector with the tip ends of the electric wires. Thus, conduction can be achieved without interposing any other conductive member between each of the tip ends of the electric wires and the target conductor. As a result, according to the connection structure, it is possible to curb the mismatching in high frequency characteristic impedances.

As one embodiment, the connection structure of above may further include a plurality of connection terminals. The plurality of connection terminals may be provided on a front surface of the board. The plurality of connection terminals may correspond to the tip ends of the plurality of electric wires, respectively. The plurality of electric wires may be configured so that each of the tip ends of the plurality of electric wires is electrically connected to each of the plurality of connection terminals. In this case, when each of the tip ends of the plurality of electric wires are electrically connected to each of the plurality of connection terminals, the function of the contacts of the electrical connector can be substituted by the tip ends of the electric wires.

As an embodiment, the connection structure according to above may include the plurality of connection terminals provided on the front surface of the board and electrically connected to corresponding electric wires among the plurality of electric wires. Each of the tip ends of the plurality of connection terminals may be located inside a corresponding insertion hole among the plurality of insertion holes. In this case, each of the tip ends of the plurality of electric wires can be electrically connected to the plurality of connection terminals more reliably.

As an embodiment, the connection structure of or above may further include a frame. The frame may surround the plurality of connection terminals in the surface direction of the board. The frame may be fitted to the ferrule main body when the electrical connector is mounted on the board. In this case, when the electrical connector is mounted on the board, the tip ends of the plurality of electric wires are positioned with higher accuracy with respect to the plurality of connection terminals. Thus, it becomes possible to curb the mismatching in high frequency characteristic impedance more reliably.

A method for manufacturing an electrical connector according to an embodiment includes steps of preparing a ferrule, preparing a plurality of electric wires, and inserting the plurality of electric wires into the plurality of insertion holes. The ferrule includes a ferrule main body and a plurality of insertion holes. The ferrule main body includes a front end and a rear end located opposite to the front end in a first direction. The plurality of insertion holes extend in the first direction within the ferrule main body. Each of the plurality of insertion holes open at the front end. In this manufacturing method, each of the tip ends of the plurality of electric wires is exposed from each of the plurality of insertion holes at the front end.

According to the above method for manufacturing an electrical connector, in the electrical connector, each of the tip ends of the plurality of electric wires are exposed from each of the plurality of insertion holes at the front end. According to such a configuration, the function of the contacts of the electrical connector can be substituted by the tip ends of the electric wires. Thus, it is possible to manufacture an electrical connector that can curb the mismatching in high frequency characteristic impedance.

As one embodiment, the method for manufacturing an electrical connector according to above may further include a step of cutting or polishing the tip end portions of plurality of electric wires so that each of the tip ends of the plurality of electric wires is flush with the front end surface in which the plurality of insertion holes are open at the front end, or protrudes a predetermined distance outward from the front end surface, after the plurality of electric wires are inserted into a plurality of electric insertion holes so that each of the tip ends extends outward from the front end. In this case, it is possible to more easily substitute the function of the contacts of the electrical connector with the tip ends of the electric wires. Thus, it is possible to easily manufacture an electrical connector that can more reliably curb the mismatching in high frequency characteristic impedance.

As an embodiment, the method for manufacturing an electrical connector according to above may further include a step of polishing the tip end portions of the plurality of electric wires so that each of the tip ends of the plurality of electric wires are located inside each of the plurality of insertion holes at the front end, after the plurality of electric wires are inserted into the plurality of insertion holes so that each of the tip ends extends outward from the front end. In this case, when the electrical connector is coupled to a mating member in the first direction, it is possible to easily manufacture an electrical connector in which a thickness of the connection structure including the electrical connector in the first direction can be reduced.

### Details of Embodiments of the Present Disclosure

Specific examples of an electrical connector, a connection structure, and a method for manufacturing the electrical connector according to embodiments of the present disclosure will be described below with reference to the drawings. In the following description, the same elements or elements having the same function will be designated by the same reference numerals, and redundant description will be omitted. The present invention is not limited to these examples, but is indicated by the scope of the claims, and is intended to include all changes within the meaning and scope equivalent to the scope of the claims.

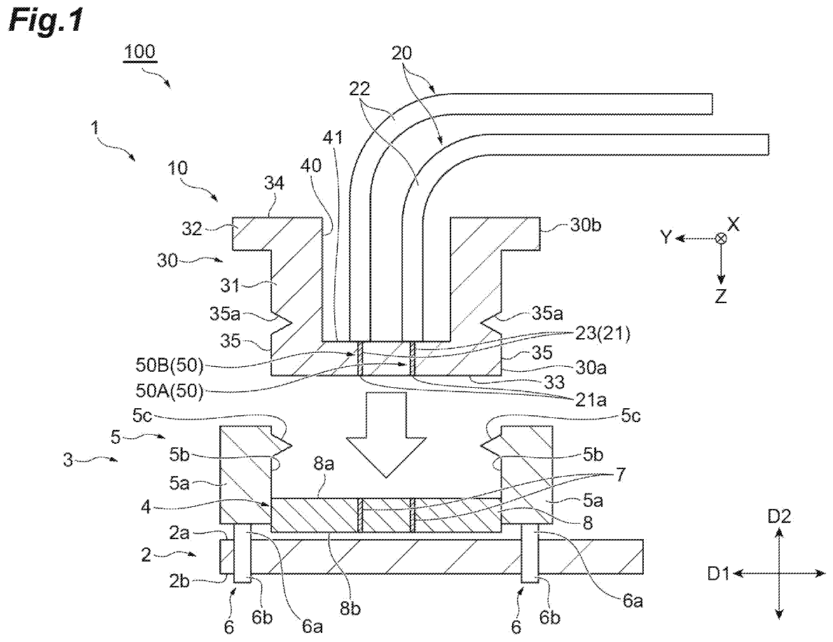

FIG. 1 is a schematic cross-sectional view showing a connection structure according to one embodiment. As shown in FIG. 1, the connection structure 100 includes an electrical connector 1, a board 2, and a mating connector 3. The electrical connector 1 is mounted on the board 2 with the mating connector 3. When the electrical connector 1 is mounted on the board 2, a plurality of electric wires 21 of the electrical connector 1 are electrically connected to a plurality of connection terminals 7 of the mating connector 3, respectively.

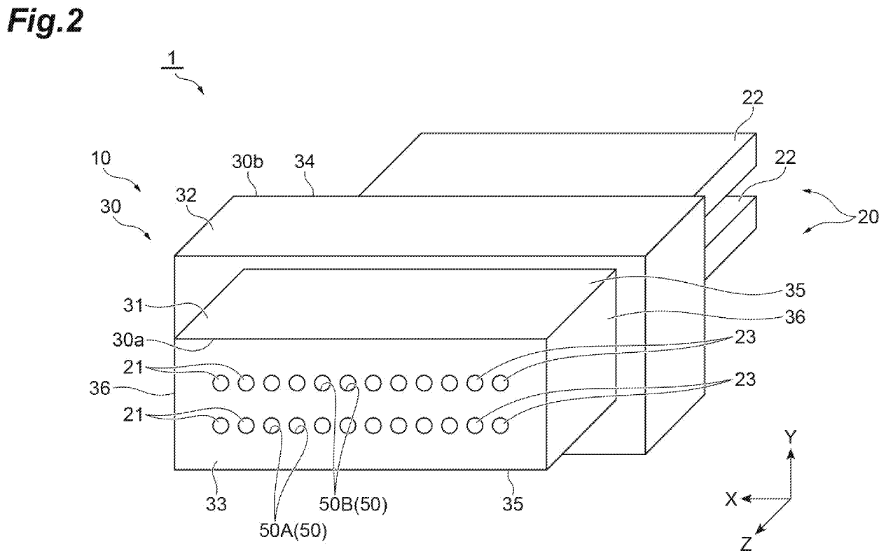

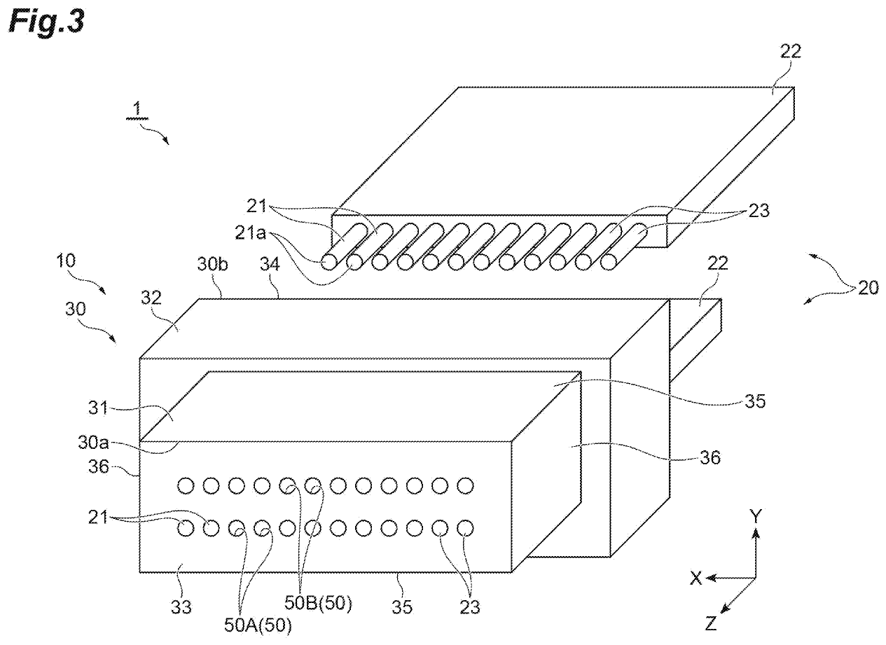

FIG. 2 is a perspective view showing the electrical connector 1 according to one embodiment. FIG. 3 is an exploded perspective view of the electrical connector 1. As shown in FIGS. 2 and 3, the electrical connector 1 includes a ferrule 10 and a plurality of cables 20. Each of the cables 20 includes a plurality of electric wires 21 arranged in a predetermined direction. The electrical connector 1 is a connector for electrically connecting tip ends 21a of the plurality of electric wires 21 to a plurality of connection terminals 7, respectively (refer to FIG. 1). Hereinafter, a width direction of the ferrule 10 will be referred to as an X direction (a second direction), a height direction of the ferrule 10 will be referred to as a Y direction (a third direction), and a direction intersecting the X direction and the Y direction will be referred to as a Z direction (a first direction).

The ferrule 10 is a member for electrically connecting each of the tip ends 21a of the plurality of electric wires 21 to the plurality of connection terminals 7. The ferrule 10 has a ferrule main body 30. The ferrule main body 30 has, for example, a substantially rectangular parallelepiped shape. The ferrule main body 30 accommodates and holds the plurality of electric wires 21 therein. The ferrule main body 30 is made of an insulating material such as a resin or ceramics.

The ferrule main body 30 has a main body portion 31 and a collar portion 32. The main body portion 31 and the collar portion 32 are arranged in the Z direction. The collar portion 32 is formed to be larger than the main body portion 31 when seen from the Z direction. The main body portion 31 has a front end 30a including a front end surface 33. The collar portion 32 has a rear end 30b including a rear end surface 34. The rear end 30b is located opposite to the front end 30a in the Z direction. The front end surface 33 and the rear end surface 34 are arranged in the Z direction. The front end surface 33 and the rear end surface 34 extend in the X direction and the Y direction.

The main body portion 31 further includes two first side surfaces 35 arranged in the Y direction and two second side surfaces 36 arranged in the X direction. The two first side surfaces 35 extend in the X direction and the Z direction. As shown in FIG. 1, two recessed portions 35a are respectively provided in the two first side surfaces 35 (refer to FIG. 1). The two second side surfaces 36 extend in the Y direction and the Z direction. In FIGS. 2 and 3, the recessed portions 35a are omitted.

As shown in FIG. 1, the ferrule 10 further includes a recessed portion 40 provided within the ferrule main body 30. The recessed portion 40 has a bottom surface 41 that extends in the X direction and the Y direction within the ferrule main body 30. The recessed portion 40 opens at the rear end surface 34. The recessed portion 40 extends in the Z direction within the ferrule main body 30.

As shown in FIGS. 2 and 3, the ferrule 10 further includes a plurality of insertion holes 50 provided inside the ferrule main body 30. The plurality of insertion holes 50 are configured to be able to hold the plurality of electric wires 21, respectively. The plurality of insertion holes 50 extend in the Z direction within the ferrule main body 30. Each of the plurality of insertion holes 50 opens at the front end surface 33. For example, the plurality of insertion holes 50 are through holes that extend from the bottom surface 41 of the recessed portion 40 to the front end surface 33 in the Z direction (refer to FIG. 1).

The plurality of insertion holes 50 are formed in the ferrule main body 30 so as to be arranged side-by-side in the X direction. In a cross section seen in the Z direction, a distance between the insertion holes 50 (a pitch between centers) may be, for example, 0.2 mm or more and 1.3 mm or less. The distance between the insertion holes 50 may be 0.4 mm or more and 0.8 mm or less, and is, for example, 0.6 mm. The plurality of insertion holes 50 are, for example, arranged two-dimensionally inside the ferrule main body 30. In an example shown in FIGS. 2 and 3, the plurality of insertion holes 50 include a first plurality of insertion holes 50A and a second plurality of insertion holes 50B. The second plurality of insertion holes 50B are formed at different positions from the first plurality of insertion holes 50A in the Y direction. An inner diameter of each of the insertion holes 50 may be the same as or be slightly greater than an outer diameter of a tip end portion 23 of the electric wire 21, which will be described below. The inner diameter of the insertion hole 50 may be the same as the outer diameter of the electric wire 21 that includes all or some of components such as a jacket 28 which will be described below. The inner diameter of the insertion hole 50 is, for example, 0.3 mm. The insertion hole 50 may have a circular shape or an elliptical shape in a cross section intersecting the Z direction.

Each of the plurality of cables 20 has a plurality of electric wires 21 and a protective portion 22. The plurality of electric wires 21 are disposed side-by-side in a direction intersecting a lengthwise direction. The plurality of electric wires 21 are insulated from each other. The protective portion 22 extends in the lengthwise direction of the electric wires 21 and is provided so as to surround the plurality of electric wires 21. Each of the plurality of electric wires 21 has the tip end portion 23 (a conductor) exposed from the protective portion 22. A boundary between the protective portion 22 and the tip end portion 23 is located at the recessed portion 40, for example. The tip end portion 23 is located within the insertion hole 50. The plurality of electric wires 21 arranged in the X direction are integrated at least in a region extending outward from the rear end 30b. Each of the cable 20 may be, for example, a flexible flat cable (FFC) or a spectacle-type cord having two electric wires.

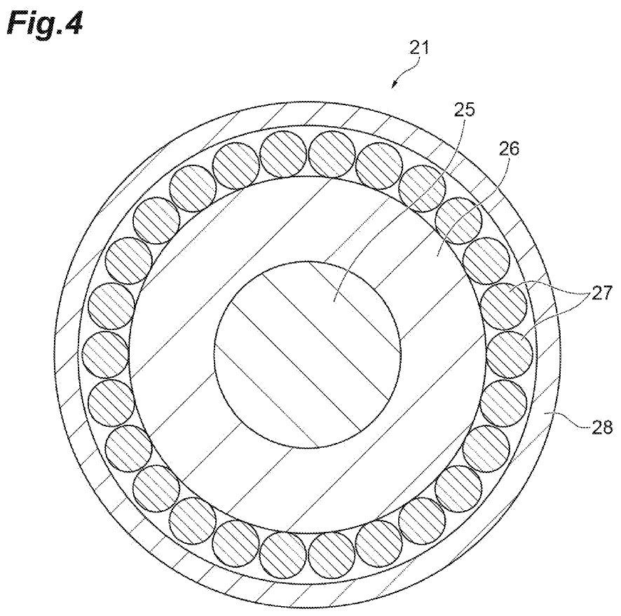

FIG. 4 is a cross-sectional view showing an example of the electric wire 21. The electric wire 21 is, for example, a coaxial cable. The electric wire 21 has a center conductor 25, an insulating layer 26 that surrounds the center conductor 25, a braided shield 27 that surrounds the insulating layer 26, and the jacket 28 that surrounds the braided shield 27. The center conductor 25 is a conductor and includes copper, for example. An outer diameter of the center conductor 25 is, for example, 0.3 mm. The insulating layer 26 is an insulator and includes polyethylene, for example. The braided shield 27 is a conductor and is electrically connected to a reference potential. The jacket 28 is an insulator and protects the center conductor 25, the insulating layer 26, and the braided shield 27 from the outside of the electric wire 21.

The tip end portions 23 of the plurality of electric wires 21 are held in the plurality of insertion holes 50, respectively. The plurality of tip end portions 23 are arranged in the X direction (the second direction) on the front end surface 33. For example, the plurality of tip end portions 23 are fixed and arranged in a two-dimensional array. Each of the tip end portions 23 has a uniform outer diameter in the Z direction. Tip ends 21a of the plurality of tip end portions 23 are respectively exposed from the plurality of insertion holes 50 on the front end surface 33. Each of the tip ends 21a of the plurality of tip end portions 23 may protrude outward from the front end surface 33, or may be flush with the front end surface 33. For example, each of the tip ends 21a protrudes from the front end surface 33 by a length that is equal to or less than the outer diameter of the tip end portion 23. As described above, the plurality of electric wires 21 are configured so that the tip ends 21a are respectively electrically connected to the plurality of connection terminals 7. For example, each of the tip ends 21a becomes a conductor when the plurality of electric wires 21 are electrically connected to the plurality of connection terminals 7.

The center conductor 25 extends in the lengthwise direction of the electric wire 21 from a distal end of the electric wire 21 to the tip end 21a. The insulating layer 26, the braided shield 27, and the jacket 28 extend at least in the lengthwise direction of the electric wire 21 from the distal end of the electric wire 21 to the boundary between the protective portion 22 and the tip end portion 23. Therefore, the tip end 21a is configured of the center conductor 25. The tip end portion 23 may be configured of the center conductor 25. The tip end portion 23 may be configured of the center conductor 25 and at least one of the insulating layer 26, the braided shield 27, and the jacket 28.

Referring again to FIG. 1, the board 2 has a first surface (a front surface) 2a and a second surface 2b located opposite to the first surface 2a. The board 2 may be a glass epoxy board or a ceramic board, for example. The mating connector 3 is provided on the board 2. The electrical connector 1 can be mounted on the board 2 with the mating connector 3 so that the Z direction intersects a surface direction D1 of the board 2.

The mating connector 3 includes a connection portion 4, a frame 5, and two supporting portions 6. The connection portion 4 includes a plurality of connection terminals 7 and a probe frame 8 in which the plurality of connection terminals 7 are provided. The probe frame 8 extends in the surface direction D1 of the board 2 and has a plate shape, for example. The probe frame 8 has a third surface 8a and a fourth surface 8b located opposite to the third surface 8a.

The plurality of connection terminals 7 are provided within the probe frame 8. The plurality of connection terminals 7 are insulated from each other by the probe frame 8. The plurality of connection terminals 7 are provided on the first surface 2a of the board 2 (the front surface of the board 2). The plurality of connection terminals 7 are arranged in the surface direction D1 of the board 2. The plurality of connection terminals 7 extend from the third surface 8a to the fourth surface 8b of the probe frame 8 in a vertical direction D2 that intersects the surface direction D1 of the board 2. The plurality of connection terminals 7 correspond to the tip ends 21a of the plurality of electric wires 21, respectively. The plurality of connection terminals 7 are configured to be electrically connectable to the tip end portions 23 of the plurality of electric wires 21, respectively. The plurality of connection terminals 7 protrude from the fourth surface 8b in the vertical direction D2. The plurality of connection terminals 7 have, for example, a needle shape. The plurality of connection terminals 7 are conductors and are made of brass, for example. An outer diameter of each of the connection terminals 7 is the same as the outer diameter of the tip end portion 23, and is, for example, 0.3 mm.

The frame 5 is provided so as to surround the plurality of connection terminals 7 in the surface direction D1 of the board 2. The frame 5 is fitted into the ferrule main body 30 when the electrical connector 1 is mounted on the board 2. The frame 5 has, for example, a rectangular frame shape. The frame 5 has two side walls 5a arranged in the surface direction D1. Protruding portions 5c are provided on inner surfaces 5b of the two side walls 5a, respectively.

The two supporting portions 6 are configured so that the frame 5 can be mounted on the board 2. The two supporting portions 6 extend in the vertical direction D2 of the board 2 and are for example, rod-shaped members. The supporting portions 6 are fixed to the board 2. Each of the supporting portions 6 has a first end 6a and a second end 6b located opposite to the first end 6a in the vertical direction D2. The first end 6a is connected to a lower portion of the frame 5. The first end 6a is located on the first surface 2a of the board 2. Each of the supporting portions 6 passes through the board 2 through a through hole provided in the board 2. The second end 6b is located on the second surface 2b of the board 2.

When the main body portion 31 is inserted inside the frame 5, the two protruding portions 5c are fitted into the two recessed portions 35a. Thus, the electrical connector 1 is fixed to the mating connector 3. At the same time, the plurality of tip end portions 23 respectively come into contact with the plurality of connection terminals 7 and push the plurality of connection terminals 7 into the probe frame 8 slightly in the vertical direction D2. In this way, the plurality of tip end portions 23 are electrically connected to the plurality of connection terminals 7, respectively.

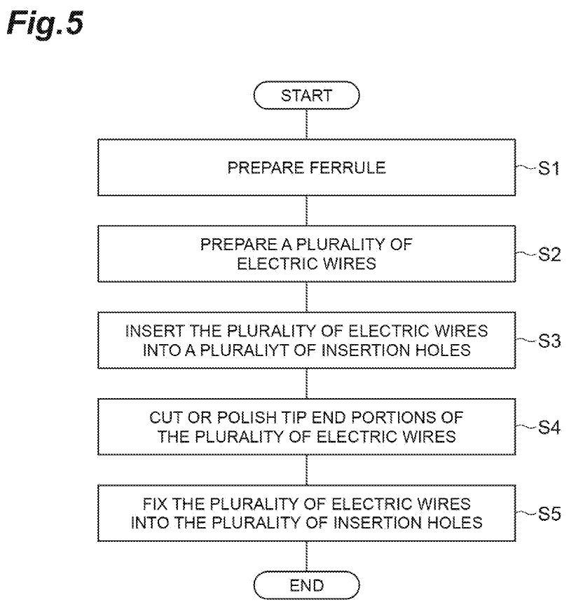

Next, a method for manufacturing the electrical connector 1 according to this embodiment will be described. FIG. 5 is a flowchart showing the method for manufacturing the electrical connector 1. In this manufacturing method, first, the ferrule 10 is prepared (Step S1). Subsequently, the plurality of electric wires 21 are prepared (Step S2). In Step S1, the ferrule 10 having the ferrule main body 30 and the plurality of insertion holes 50 and manufactured by integral molding is prepared. For example, the ferrule 10 is formed by resin molding. In Step S2, the plurality of cables 20 are prepared in which the tip end portions 23 of the plurality of electric wires 21 are exposed from the protective portion 22.

Subsequently, the plurality of electric wires 21 are inserted into the plurality of insertion holes 50, respectively (Step S3). In Step S3, the tip end portions 23 of the plurality of electric wires 21 are inserted into the plurality of insertion holes 50, respectively. At this time, each of the tip ends 21a of the plurality of electric wires 21 is exposed from each of the plurality of insertion holes 50 at the front end 30a. In this way, the plurality of electric wires 21 are inserted into the plurality of insertion holes 50 so that each of the tip ends 21a extends outward from the front end 30a.

Subsequently, the tip end portions 23 of the plurality of electric wires 21 are cut or polished (Step S4). Subsequently, the plurality of electric wires 21 are respectively fixed in the plurality of insertion holes 50 (Step S5). In Step S4, the tip end portions 23 of the plurality of electric wires 21 are cut or polished so that each of the tip ends 21a of the plurality of electric wires 21 is flush with the front end surface 33 in which the plurality of insertion holes 50 are open at the front end 30a. Alternatively, the tip end portions 23 of the plurality of electric wires 21 are cut or polished so that each of the tip ends 21a of the plurality of electric wires 21 protrudes a predetermined distance outward from the front end surface 33. At this time, the plurality of tip end portions 23 are cut or polished so that lengths of the portions protruding from the front end surface 33 are the same. The predetermined distance may be equal to or less than the outer diameter of the tip end portion 23, for example. At this time, the ferrule main body (a casing) 30 becomes easier to cut than the electric wire 21 by making a hardness of the ferrule main body (the casing) 30 smaller than that of the electric wire 21. For example, a material forming the ferrule main body 30 is a resin. In such a case, when the tip end portions 23 of the plurality of electric wires 21 and the front end surface 33 are polished, the tip ends 21a of the tip end portions 23 of the electric wires 21 can be made to protrude a predetermined distance from the front end surface 33 by adjusting polishing conditions. In Step S5, the tip end portions 23 of the plurality of electric wires 21 are fixed to the plurality of insertion holes 50, respectively. After the electric wire is fixed in Step S5, the tip end portions of the electric wires may be cut or polished in Step S4. As described above, the electrical connector 1 according to the embodiment is manufactured by performing Steps S1 to S5.

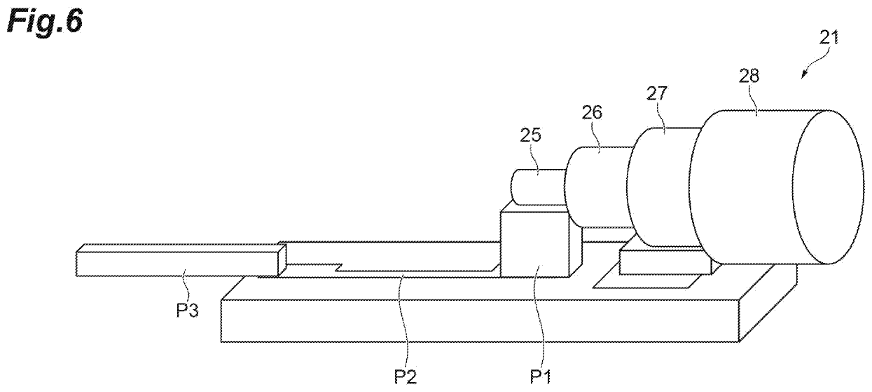

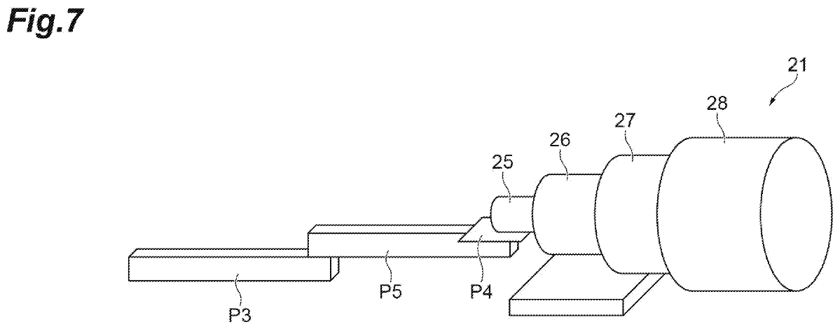

Hereinafter, effects of the electrical connector 1, the connection structure 100, and the method for manufacturing the electrical connector 1 according to this embodiment will be described in comparison with a case of a conventional electrical connector shown in FIGS. 6 and 7. In the conventional electrical connector, each of the electric wires is electrically connected to a conductor provided on a board through contacts such as terminals and electrode pads. FIG. 6 is a schematic perspective view showing a card edge type electrical connector. In such a conventional connector, mismatching in high frequency characteristic impedance occurs between the electric wires 21 (conductors) and the contacts (at a joint portion between the conductor and the contact).

In the example shown in FIG. 6, the center conductor 25 is connected to a conductor P3 with a contact P1 and an electrode pad P2. The contact P1 and the electrode pad P2 have a different shape from the electric wire 21. For example, the electric wire 21, the contact P1, and the electrode pad P2 have mutually different outer diameters, cross-sectional shapes, and positions with respect to the ground. The electric wire 21, the contact P1, and the electrode pad P2 have high frequency characteristic impedances that are different from each other.

FIG. 7 is a schematic perspective view showing a contact pin type electrical connector. In the example shown in FIG. 7, the center conductor 25 is connected to the conductor P3 on the board with an electrode pad P4 and a contact pin P5. For example, the electric wire 21, the electrode pad P4, and the contact pin P5 have mutually different outer diameters, cross-sectional shapes, and positions with respect to the ground. The electric wire 21, the electrode pad P4, and the contact pin P5 have high frequency characteristic impedances that are different from each other.

On the other hand, according to the electrical connector 1 according to this embodiment, each of the tip ends 21a of the plurality of electric wires 21 is exposed from each of the plurality of insertion holes 50 at the front end 30a. According to such a configuration, a function of the contact of the electrical connector 1 can be substituted by the tip end 21a of the electric wire 21. Thus, there is no need to interpose another conductive member between each of the tip ends 21a of the electric wires 21 and each of the connection terminals 7. As a result, it becomes possible to match the high frequency characteristic impedance between each of the tip ends 21a of the electric wires 21 and each of the connection terminals 7 by making the outer diameter and the cross-sectional shape of each of the tip ends 21a of the electric wires 21 correspond to the outer diameter and the cross-sectional shape of each of the connection terminals 7. Therefore, it becomes possible to curb mismatching in the high frequency characteristic impedance. Since there is no need to interpose another conductive member between each of the tip ends 21a of the electric wires 21 and each of the connection terminals 7, a thickness of the electrical connector 1 in the Z direction is reduced, and a height of the electrical connector 1 can be reduced.

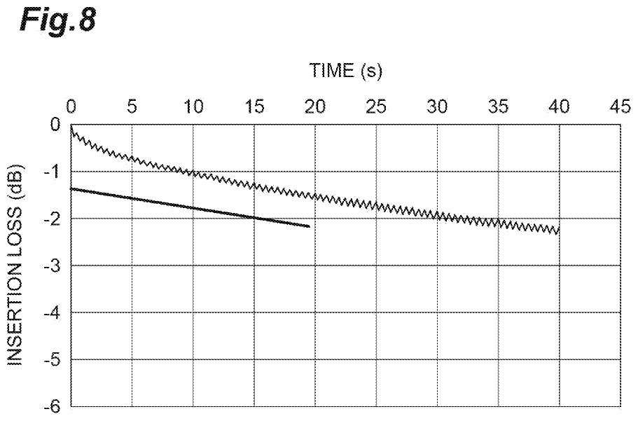

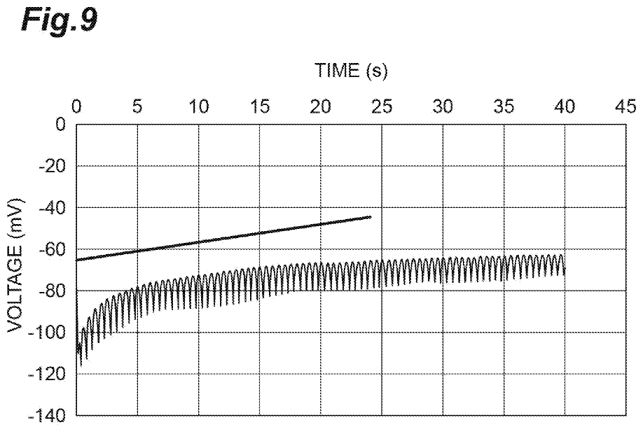

FIG. 8 is a graph showing insertion loss in a connection structure 100. FIG. 9 is a graph showing crosstalk in the connection structure 100. A horizontal axis in each of FIGS. 8 and 9 indicates time (seconds). A vertical axis in FIG. 8 indicates insertion loss (dB). A vertical axis in FIG. 9 indicates a voltage (mV). In the connection structure 100, since the function of the contact of the electrical connector 1 can be substituted by the tip end 21a of the electric wire 21, it becomes possible to make the outer diameter of the tip end 21a of the electric wire 21 correspond to the outer diameter of the connection terminal 7. In this case, as shown in FIGS. 8 and 9, generation of resonance points is curbed in the graphs showing the insertion loss and the crosstalk. Therefore, it is possible to curb the mismatching in the high frequency characteristic impedance.

In the electrical connector 1 according to this embodiment, the ferrule main body 30 is made of an insulating material. In this case, it is possible to prevent the plurality of electric wires 21 from being electrically connected to anything other than the connection terminals 7.

In the electrical connector 1 according to this embodiment, the plurality of insertion holes 50 may be formed in the ferrule main body 30 so as to be arranged side-by-side in the X direction. In this case, the plurality of electric wires 21 can be disposed with a higher density at the front end 30a.

In the electrical connector 1 according to this embodiment, the plurality of insertion holes 50 include a first plurality of insertion holes 50A and a second plurality of insertion holes 50B. The first plurality of insertion holes 50A are formed to be arranged side-by-side in the X direction. The second plurality of insertion holes 50B are formed to be arranged side-by-side in the X direction and formed at different positions from the first plurality of insertion holes 50A in the Y direction. In this case, the plurality of electric wires 21 can be disposed with a higher density at the front end 30a.

In the electrical connector 1 according to this embodiment, each of the tip ends 21a of the plurality of electric wires 21 is flush with the front end surface 33 in which the plurality of insertion holes 50 are open at the front end 30a, or each of the tip ends 21a of the plurality of electric wires 21 protrudes outward from the front end surface 33. In this case, it is possible to more easily substitute the function of the contact of the electrical connector 1 with the tip end 21a of the electric wire 21. Thus, it becomes possible to curb the mismatching in the high frequency characteristic impedance more reliably.

In the electrical connector 1 according to this embodiment, each of the plurality of electric wires 21 has the tip end portion 23 held in at least each of the plurality of insertion holes 50. The tip end portion 23 has a uniform outer diameter in the Z direction. In this case, since it becomes possible to more reliably make the outer diameter and the cross-sectional shape of each of the tip ends 21a of the electric wires 21 correspond to the outer diameter and the cross-sectional shape of each of the connection terminals 7, it becomes possible to match the high frequency characteristic impedance between each of the tip ends 21a of the electric wires 21 and each of the connection terminals 7 more reliably. Therefore, it becomes possible to curb the mismatching in the high frequency characteristic impedance more reliably.

The plurality of insertion holes 50 have an elliptical shape in a cross section intersecting the Z direction. In this case, it is possible to make an adjacent ground line, which serves as a reference ground for the electric wire 21, in an elliptical shape, and to have a structure in which a major axis of the elliptical shape is perpendicular or parallel to the X direction. Thus, crosstalk between the electric wires 21 can be curbed.

In the electrical connector 1 according to this embodiment, the plurality of electric wires 21 are integrated at least in a region that extends outward from the rear end 30b. In this case, handling of the plurality of electric wires 21 extending outward from the rear end 30b of the ferrule 10 becomes easier. Furthermore, when the electrical connector 1 is manufactured, it becomes easier to insert the plurality of electric wires 21 into the ferrule 10, and it is possible to easily realize a configuration in which the plurality of electric wires 21 are disposed with a high density at the front end 30a.

The connection structure 100 according to this embodiment includes the board 2 and the electrical connector 1 described above. The electrical connector 1 can be mounted on the board 2 so that the Z direction intersects the surface direction D1 of the board 2. In this case, when the plurality of electric wires 21 are electrically connected to the plurality of connection terminals 7, respectively, it becomes possible to substitute the function of the contacts of the electrical connector 1 with the tip ends 21a of the electric wires 21. Thus, there is no need to interpose another conductive member between each of the tip ends 21a of the electric wires 21 and each of the connection terminals 7. As a result, it becomes possible to match the high frequency characteristic impedance between each of the tip ends 21a of the electric wires 21 and each of the connection terminals 7 by making the outer diameter and the cross-sectional shape of each of the tip ends 21a of the electric wires 21 correspond to the outer diameter and the cross-sectional shape of each of the connection terminals 7. Therefore, it becomes possible to curb the mismatching in the high frequency characteristic impedance. Further, since there is no need to interpose another conductive member between each of the tip ends 21a of the electric wires 21 and each of the connection terminals 7, the thickness of the connection structure 100 in the Z direction is reduced, and the height of the connection structure 100 can be reduced.

The connection structure 100 according to this embodiment further includes the plurality of connection terminals 7. The plurality of connection terminals 7 are provided on the first surface 2a of the board 2, and correspond to the tip ends 21a of the plurality of electric wires 21, respectively. The plurality of electric wires 21 are configured so that each of the tip ends 21a is electrically connected to each of the plurality of connection terminals 7. In this case, when the tip ends 21a of the plurality of electric wires 21 are electrically connected to the plurality of connection terminals 7, the function of the contacts of the electrical connector 1 can be substituted by the tip ends 21a of the electric wires 21.

The connection structure 100 according to this embodiment further includes the frame 5. The frame 5 surrounds the plurality of connection terminals 7 in the surface direction D1 of the board 2. The frame 5 is fitted into the ferrule main body 30 when the electrical connector 1 is mounted on the board 2. In this case, when the electrical connector 1 is mounted on the board 2, the tip ends 21a of the plurality of electric wires 21 are positioned with higher accuracy with respect to the plurality of connection terminals 7. Thus, it becomes possible to curb the mismatching in high frequency characteristic impedance.

In the connection structure 100 described above, the ferrule main body 30 holds the tip ends 21a of the plurality of electric wires 21 and is fitted into the frame 5. Thus, the position of each of the tip ends 21a of the plurality of electric wires 21 with respect to the plurality of connection terminals 7 can be guaranteed.

The method for manufacturing the electrical connector 1 according to this embodiment includes steps of preparing the ferrule 10, preparing the plurality of electric wires 21, and inserting the plurality of electric wires 21 into the plurality of insertion holes 50, respectively. The ferrule 10 has the ferrule main body 30 and the plurality of insertion holes 50. The ferrule main body 30 has the front end 30a and the rear end 30b located opposite to the front end 30a in the Z direction. The plurality of insertion holes 50 extend within the ferrule main body 30 in the Z direction. Each of the plurality of insertion holes 50 is open at the front end 30a. In this manufacturing method, each of the tip ends 21a of the plurality of electric wires 21 is exposed from each of the plurality of insertion holes 50 at the front end 30a.

According to the method for manufacturing the electrical connector 1 described above, in the electrical connector 1, each of the tip ends 21a of the plurality of electric wires 21 is exposed from each of the plurality of insertion holes 50 at the front end 30a. According to such a configuration, the function of the contacts of the electrical connector 1 can be substituted by the tip ends 21a of the electric wires 21. Thus, it is possible to manufacture the electrical connector 1 that can curb the mismatching in the high frequency characteristic impedance.

The method for manufacturing the electrical connector 1 according to this embodiment further includes a step of cutting or polishing the tip end portions 23 of the plurality of electric wires 21 so that each of the tip ends 21a of the plurality of electric wires 21 is flush with the front end surface 33 in which the plurality of insertion holes 50 are open at the front end 30a, or protrudes a predetermined distance outward from the front end surface 33, after the plurality of electric wires 21 are respectively inserted into the plurality of insertion holes 50 so that each of the tip ends 21a extends outward from the front end 30a. In this case, it is possible to more easily substitute the function of the contacts of the electrical connector 1 with the tip ends 21a of the electric wires 21. Thus, it is possible to manufacture the electrical connector 1 that can more reliably curb the mismatching in the high frequency characteristic impedance. Moreover, since a step of interposing another conductive member between each of the tip ends 21a of the electric wires 21 and each of the connection terminals 7 is not necessary, it is possible to manufacture the electrical connector 1 with a reduced height.

Although the electrical connector 1, the connection structure 100, and the method for manufacturing the electrical connector 1 according to the present disclosure have been described above in detail, the present invention is not limited to the above embodiment, and can be applied to various embodiments and modified examples. Specifically, in the embodiment described above, although each of the tip ends 21a of the plurality of tip end portions 23 protrudes outward from the front end surface 33 or is flush with the front end surface 33, it may be located inside each of the plurality of insertion holes 50 at the front end 30a.

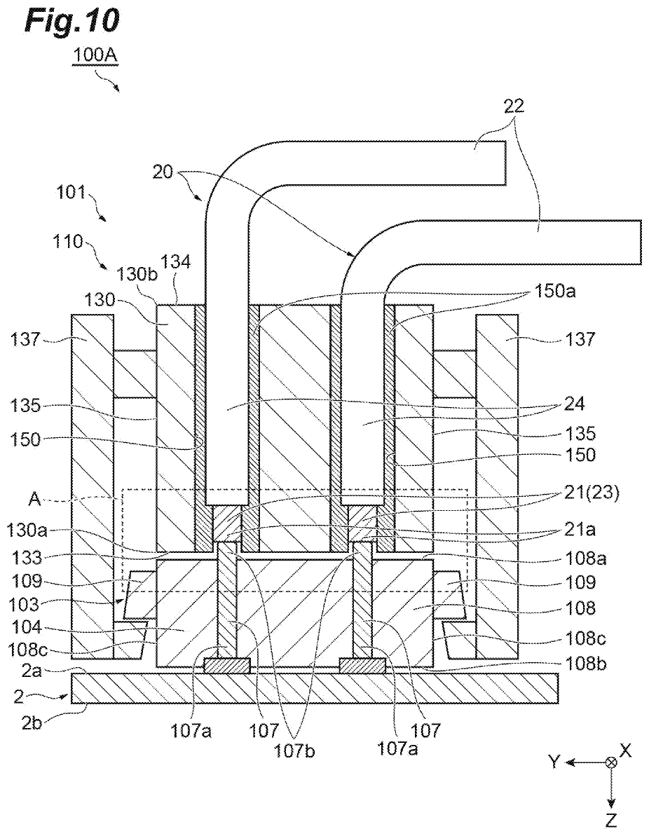

FIG. 10 is a cross-sectional view showing a connection structure according to a modified example. As shown in FIG. 10, the connection structure 100A includes an electrical connector 101, a board 2, and a mating connector 103, as in the above embodiment. The electrical connector 101 includes a ferrule 110 and a plurality of cables 20. The ferrule 110 has a ferrule main body 130 and a plurality of insertion holes 150.

The ferrule main body 130 has a front end 130a and a rear end 130b. The front end 130a and the rear end 130b are arranged in the Z direction. The front end 130a includes a front end surface 133 that extends in the X direction and the Y direction. The rear end 130b includes a rear end surface 134 that extends in the X direction and the Y direction. The ferrule main body 130 has two first side surfaces 135 arranged in the Y direction and two second side surfaces (not shown) arranged in the X direction. Unlike the above embodiment, the ferrule main body 130 has a pair of arm portions 137 provided on the pair of first side surfaces 135, respectively, instead of the two recessed portions 35a.

The tip end portions 23 of the plurality of electric wires 21 are held in the plurality of insertion holes 150, respectively. The tip end portion 24 of the protective portion 22 is held in each of the plurality of insertion holes 150. The inside of each of the plurality of insertion holes 150 is filled with an adhesive 150a. The tip end portions 23 of the plurality of electric wires 21 and the tip end portion 24 of the protective portion 22 are fixed to the insertion holes 150, for example, with the adhesive 150a. Each of the tip ends 21a of the plurality of tip end portions 23 is exposed from each of the plurality of insertion holes 150 at the front end surface 133, but is located inside each of the plurality of insertion holes 150 at the front end 130a.

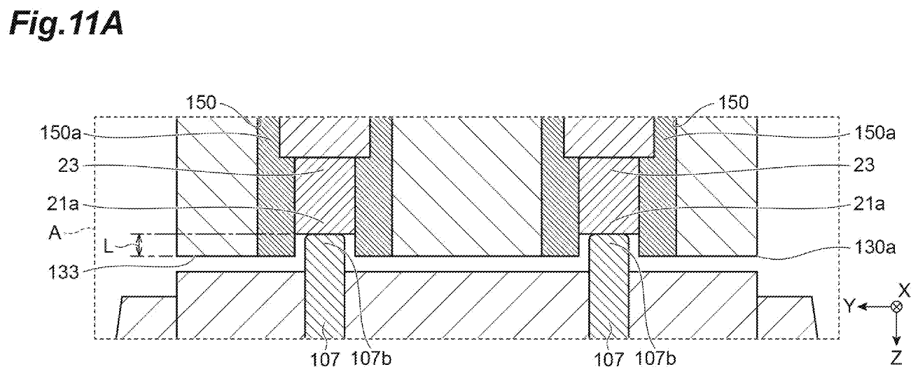

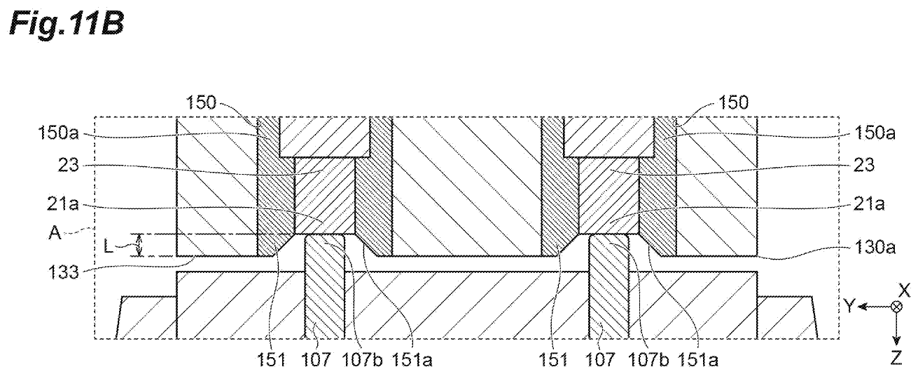

FIGS. 11A and 11B are enlarged views of a region A in the connection structure 100A according to the modified example. As shown in FIGS. 11A and 11B, a distance L between each of the tip ends 21a and the front end surface 133 is, for example, 30 μm or more and 600 μm or less. As shown in FIG. 11B, each of the plurality of insertion holes 150 may have a flared portion 151. The flared portion 151 widens toward the front end surface 133 from inside each of the plurality of insertion holes 150 at the front end 130a. An inner surface 151a of the flared portion 151 may be inclined at an angle of 30 degrees or more and 45 degrees or less with respect to the Z direction. Although the flared portion 151 is formed by polishing the adhesive 150a, it may also be formed by polishing the ferrule main body 130.

The mating connector 103 has a connection portion 104. The connection portion 104 includes a plurality of connection terminals 107 and a probe frame 108 in which the plurality of connection terminals 107 are provided. The probe frame 108 has a third surface 108a and a fourth surface 108b located opposite to the third surface 108a in the Z direction.

The plurality of connection terminals 107 are provided on the first surface 2a of the board 2. Each of distal ends 107a of the plurality of connection terminals 107 is electrically connected to a wiring within the board 2, for example, by soldering. The plurality of connection terminals 107 are electrically connected to corresponding electric wires 21 among the plurality of electric wires 21, respectively. Each of tip ends 107b of the plurality of connection terminals 107 protrude from the third surface 108a toward the electrical connector 101 in the vertical direction D2. The tip ends 107b are located inside corresponding insertion holes 150 among the plurality of insertion holes 150. In a modified example, the plurality of connection terminals 107 are made of, for example, an elastically deformable material, and are, for example, pin contacts.

The mating connector 103 further includes a pair of protruding portions 109. The probe frame 108 has a pair of side surfaces 108c arranged in the Y direction. The pair of side surfaces 108c extend in the X direction and the Z direction. The pair of protruding portions 109 are provided on the pair of side surfaces 108c, respectively. When the electrical connector 101 is mounted to the mating connector 103, the pair of arm portions 137 extend in the Z direction from positions at which they sandwich the pair of first side surfaces 135 in the Y direction to positions at which they sandwich the probe frame 108 in the Y direction, and engage with the pair of protruding portions 109, respectively. Thus, the electrical connector 101 is fixed to the mating connector 103.

Next, with reference to FIG. 5, a method for manufacturing the electrical connector 101 according to a modified example will be described. In the modified example, unlike the above embodiment, Step S5 is not performed, and instead, the step performed in Step S5 is performed in Step S4. Specifically, first, the ferrule 10 is prepared (Step S1). Subsequently, the plurality of electric wires 21 are prepared (Step S2). Subsequently, the plurality of electric wires 21 are inserted into the plurality of insertion holes 50, respectively (Step S3). Subsequently, the tip end portions 23 of the plurality of electric wires 21 are polished (Step S4).

Specifically, in Steps S3 and S4 in the modified example, the tip end portions 23 of the plurality of electric wires 21 are polished, or the tip end portions 23 of the plurality of electric wires 21 are cut and then polished. More specifically, the plurality of electric wires 21 are inserted into the plurality of insertion holes 150 so that each of the tip ends 21a extends outward from the front end 130a (Step S3). Subsequently, the plurality of electric wires 21 are respectively fixed to the plurality of insertion holes 150 using, for example, an adhesive 150a (Step S4). At this time, since a protruding length of each of the tip end portions 23 of the electric wires 21 from the front end surface 133 varies for each of the electric wires 21, the electrical connector 101 cannot stably physically come into contact with the mating connector 103 when the electrical connector 101 is connected to the mating connector 103.

Subsequently, the tip end portions 23 of the plurality of electric wires 21 are polished so that each of the tip ends 21a of the plurality of electric wires 21 is located inside each of the plurality of insertion holes 150 at the front end 130a (Step S4). At this time, the plurality of tip end portions 23 are polished so that distances between the tip end 21a and the front end surface 133 are the same. At this time, the electric wire 21 is more easily cut than the ferrule main body (a casing) 130 by making a hardness of the electric wire 21 smaller than a hardness of the ferrule main body (the casing) 130. For example, a material forming the ferrule main body 130 is ceramics such as zirconia. In such a case, when the tip end portions 23 of the plurality of electric wires 21 and the front end surface 133 are polished, a distance L between each of the tip ends 21a of the plurality of electric wires 21 and the front end surface 133 is set to a predetermined distance by adjusting polishing conditions. The tip ends 21a of the tip end portions 23 of the electric wires 21 are provided at positions deeper than the front end surface 133 of the ferrule main body 130. Since the front end surface 133 and each of the tip ends 21a are prepared by polishing, flatness of the front end surface 133 and each of the tip ends 21a can be improved. Therefore, the electrical connector 101 can stably physically come into contact with the mating connector 103.

In Step S3, the plurality of electric wires 21 may be inserted into the ferrule main body 130 so that each of the tip ends 21a of the plurality of electric wires 21 is located inside each of the plurality of insertion holes 150 at the front end 130a. In this case, the plurality of electric wires 21 may be inserted into the ferrule main body 130 so that each of the tip ends 21a of the plurality of electric wires 21 is positioned inside each of the plurality of insertion holes 150 with the positions of the respective tip ends 21a aligned in the Z direction (Step S3). Subsequently, the plurality of electric wires 21 may be respectively fixed to the plurality of insertion holes 150, for example, with the adhesive 150a (Step S4). Finally, the position of the front end surface 133 in the Z direction may be adjusted by polishing the front end surface 133 so that the distance L between each of the tip ends 21a and the front end surface 133 becomes a predetermined distance.

As described above, the electrical connector 101 according to the embodiment is manufactured by performing Steps S1 to S4.

In the electrical connector 101 according to the modified example, it is possible to curb the mismatching in the high frequency characteristic impedance, as in the above embodiment. Moreover, the height of the electrical connector 101 can be reduced.

In the electrical connector 101 according to the modified example, each of the tip ends 21a of the plurality of electric wires 21 is located inside each of the plurality of insertion holes 150 at the front end 130a. In this case, when the electrical connector 101 is coupled to the mating connector 103 in the Z direction, each of the plurality of connection terminals 107 of the mating connector 103 can enter inside the insertion hole 150 that holds the corresponding electric wire 21 among the plurality of electric wires 21. Thus, a thickness of the connection structure 100A including the electrical connector 101 in the Z direction can be reduced. As a result, when the connection terminals 107 of the mating connector 103 are made of, for example, an elastically deformable material, a long space for providing the plurality of connection terminals 107 can be secured in the Z direction. Therefore, an amount of displacement of the connection terminals 107 can be set to a large value, and each of the tip ends 21a and the connection terminals 107 can be electrically connected even more stably.

In the electrical connector 101 according to the modified example, the distance between each of the tip ends 21a of the plurality of electric wires 21 and the front end surface 133 in which the plurality of insertion holes 150 are open at the front end 130a is 30 μm or more and 600 μm or less. In this case, since the distance between the tip end 21a and the front end surface 133 is 30 μm or more, a thickness of the connection structure 100A including the electrical connector 101 in the Z direction can be made thinner. Furthermore, since the distance between the tip end 21a and the front end surface 133 is 600 μm or less, each of the tip ends 21a of the plurality of electric wires 21 can be more reliably connected to the connection terminals 107 inserted into each of the insertion holes 150.

In the electrical connector 101 according to the modified example, each of the plurality of insertion holes 150 includes a flared portion 151 that, at the front end 130a, widens from the inside of each of the plurality of insertion holes 150 toward the front end surface 133 in which the plurality of insertion holes 150 are open. In this case, when the electrical connector 101 is coupled to the mating connector 103 in the Z direction, the flared portion 151 of each of the insertion holes 150 can guide a corresponding one of the plurality of connection terminals 107 of the mating connector 103 into the insertion hole 150. Thus, in the X direction and the Y direction, the position of each of the tip ends 21a of the plurality of electric wires 21 can be positioned with higher precision with respect to the corresponding one of the plurality of connection terminals 107.

In the connection structure 100A according to the modified example, it is possible to curb the mismatch in the high frequency characteristic impedance, as in the above embodiment. Moreover, the height of the connection structure 100A can be reduced.

The connection structure 100A according to a modified example includes the plurality of connection terminals 107. The plurality of connection terminals 107 are provided on the first surface 2a of the board 2. Each of the plurality of connection terminals 107 are electrically connected to corresponding the electric wires 21 among the plurality of electric wires 21, respectively. Each of the tip ends 107b of the plurality of connection terminals 107 is located inside the corresponding insertion hole 150 among the plurality of insertion holes 150. For example, each of the tip ends 107b of the plurality of connection terminals 107 protrude from the third surface 108a of the probe frame 108 in the Z direction. In this case, each of the tip ends 21a of the plurality of electric wires 21 can be electrically connected to each of the plurality of connection terminals 107 more reliably.

In the method for manufacturing the electrical connector 101 according to the modified example, it is possible to manufacture the electrical connector 101 that can curb the mismatch in the high frequency characteristic impedance, as in the above embodiment. Furthermore, it is possible to manufacture the electrical connector 101 with a reduced height.

The method for manufacturing the electrical connector 101 according to the modified example includes a polishing step. In the polishing step, after the plurality of electric wires 21 are inserted into the plurality of insertion holes 150 so that each of the tip ends 21a extends outward from the front end 130a, the tip end portions 23 of the plurality of electric wires 21 are polished so that each of the tip ends 21a of the plurality of electric wires 21 is located inside each of the plurality of insertion holes 150 at the front end 130a. In this case, when the electrical connector 101 is coupled to the mating connector 103 in the Z direction, the electrical connector 101 that can reduce the thickness of the connection structure 100A including the electrical connector 101 in the Z direction can be easily manufactured.

In the above embodiment and modified example, the electrical connector 1 may further include a plurality of optical fibers. The plurality of electric wires 21 may be held in each of the first plurality of insertion holes 50A. The plurality of optical fibers may be held in each of the second plurality of insertion holes 50B. Like the electrical connector 1, the electrical connector 101 may include a plurality of optical fibers. Therefore, the electrical connectors 1 and 101 may be composite opto-electrical array connector. In this case, both the plurality of electric wires 21 and the plurality of optical fibers can be disposed with higher density and higher precision.

In the above embodiment, the connection structure 100 only needs to have the electrical connector 1 and the mating connector 3. In the modified example, the connection structure 100A only needs to have the electrical connector 101 and the mating connector 103. Specifically, the connection structures 100 and 100A do not need to have the board 2. In this case, a plurality of electric wires other than the plurality of electric wires 21 may be electrically connected to each of the connection terminals 7 and 107 of the mating connectors 3 and 103. In such connection structures 100 and 100A, the tip ends 21a of electric wires 21 are electrically connected to a plurality of other electric wires, respectively.

In the above embodiment and modified example, the electric wire 21 is, for example, a coaxial cable, but any cable may be used as long as it has a conductor extending in a lengthwise direction. For example, the electric wire 21 may be a twin axial cable (Twinax cable) or may be a cable other than the above. Therefore, the electrical connectors 1 and 101 may be micro Coax two-dimensional array connectors or micro Twinax two-dimensional array connectors.

Although each of the cables 20 had the plurality of electric wires 21 arranged in the X direction in the above embodiment and modified example, the present invention is not limited thereto. For example, the cable 20 may have the plurality of electric wires 21 arranged in the X direction and the Y direction. Therefore, the electrical connectors 1 and 101 may be FFC two-dimensional array connectors.

In the above embodiment and modified example, the distance (the pitch) between the insertion holes 50, 150 is not limited to the above in the cross section seen in the Z direction. For example, the distance between the insertion holes 50, 150 may be 0.12 mm. In this case, the outer diameter of the tip end portion 23 may be 35 μm. Such electrical connectors 1 and 101 are connectors that hold electric wires 21 of about 10 to 20 cores, and are used, for example, in endoscopes or catheters.

In the embodiment described above, the electrical connector 1 was used in the connection structure 100, but the present invention is not limited thereto. In the modified example, the electrical connector 101 was used in the connection structure 100A, but the present invention is not limited thereto. For example, the electrical connectors 1 and 101 may be in-line connectors, may be on-site connectors that can be manufactured by workers on-site, or may be connectors used for other purposes than those described above.

What is claimed is:

1. An electrical connector comprising:
a ferrule including a ferrule main body including a front end and a rear end located opposite to the front end in a first direction and a plurality of insertion holes that extend in the first direction within the ferrule main body and that respectively open at the front end; and
a plurality of electric wires each held in the plurality of insertion holes,
wherein each of tip ends of the plurality of electric wires is exposed from each of the plurality of insertion holes at the front end.

2. The electrical connector according to claim 1, wherein the ferrule main body is made of an insulating material.

3. The electrical connector according to claim 1, wherein the plurality of insertion holes are formed in the ferrule main body to be arranged side-by-side in a second direction intersecting the first direction.

4. The electrical connector according to claim 1, wherein the plurality of insertion holes includes a first plurality of insertion holes formed side-by-side in a second direction intersecting the first direction, and a second plurality of insertion holes formed side-by-side in the second direction and at different positions from those of the first plurality of insertion holes in a third direction intersecting the first direction and the second direction.

5. The electrical connector according to claim 4, further comprising a plurality of optical fibers,
wherein each of the plurality of electric wires is held in each of the first plurality of insertion holes, and each of the plurality of optical fibers is held in each of the second plurality of insertion holes.

6. The electrical connector according to claim 1, wherein each of the tip ends of the plurality of electric wires is flush with a front end surface in which the plurality of insertion holes are open at the front end, or protrudes outward from the front end surface.

7. The electrical connector according to claim 1, wherein each of the tip ends of the plurality of electric wires is located inside each of the plurality of insertion holes at the front end.

8. The electrical connector according to claim 7, wherein a distance between each of the tip ends of the plurality of electric wires and a front end surface in which the plurality of insertion holes are open at the front end is 30 μm or more and 600 μm or less.

9. The electrical connector according to claim 7, wherein each of the plurality of insertion holes includes, at the front end, a flared portion that widens from an inside of each of the plurality of insertion holes toward a front end surface in which the plurality of insertion holes are open.

10. The electrical connector according to claim 1, wherein each of the plurality of electric wires includes a tip end portion held in each of at least the plurality of insertion holes, and the tip end portion has a uniform outer diameter in the first direction.

11. The electrical connector according to claim 1, wherein the plurality of insertion holes have a circular or elliptical shape in a cross section intersecting the first direction.

12. The electrical connector according to claim 1, wherein the plurality of electric wires are integrated at least in a region that extends outward from the rear end.

13. A connection structure comprising:
a board; and
the electrical connector according to claim 1,
wherein the electrical connector is configured to be mounted on the board so that the first direction intersects a surface direction of the board.

14. The connection structure according to claim 13, further comprising a plurality of connection terminals provided on a front surface of the board and corresponding to the tip ends of the plurality of electric wires, respectively,
wherein the plurality of electric wires are configured so that each of the tip ends of the plurality of electric wires is electrically connected to each of the plurality of connection terminals.

15. The connection structure according to claim 13, further comprising a plurality of connection terminals provided on a front surface of the board and electrically connected to corresponding electric wires among the plurality of electric wires, respectively,
wherein each of the tip ends of the plurality of connection terminals is located inside a corresponding insertion hole among the plurality of insertion holes.

16. The connection structure according to claim 14, further comprising a frame that surrounds the plurality of connection terminals in the surface direction of the board, wherein the frame is fitted to the ferrule main body when the electrical connector is mounted on the board.

17. A method for manufacturing an electrical connector, comprising:
preparing a ferrule including a ferrule main body including a front end and a rear end located opposite to the front end in a first direction, and a plurality of insertion holes that extend in a first direction within the ferrule main body and that respectively open at the front end;
preparing a plurality of electric wires; and
inserting each of the plurality of electric wires into each of the plurality of insertion holes,
wherein each of tip ends of the plurality of electric wires is exposed from each of the plurality of insertion holes at the front end.

18. The method for manufacturing an electrical connector according to claim 17, further comprising,
cutting or polishing tip end portions of the plurality of electric wires so that each of the tip ends of the plurality of electric wires is flush with a front end surface in which the plurality of insertion holes are open at the front end, or protrudes a predetermined distance outward from the front end surface, after the plurality of electric wires are inserted into the plurality of insertion holes so that each of the tip ends extends outward from the front end.

19. The method for manufacturing an electrical connector according to claim 17, further comprising,
polishing tip end portions of the plurality of electric wires so that each of the tip ends of the plurality of electric wires is located inside each of the plurality of insertion holes at the front end, after the plurality of electric wires are inserted into the plurality of insertion holes so that each of the tip ends extends outward from the front end.
